(19) United States
(12) Patent Application Publication
(10) Pub. No.: US 2006/0136333 A1
(43) Pub. Date: Jun. 22, 2006

(54) System and method for servicing student financial needs

(76) Inventors: Nina K. Vellayan, Reston, VA (US); Mark G. Overend, McLean, VA (US)

Correspondence Address: DICKSTEIN SHAPIRO MORIN & OSHINSKY LLP, 2101 L Street, NW, Washington, DC, 20037, US

(21) Appl. No.: 11/283,707

(22) Filed: Nov. 22, 2005

Related U.S. Application Data
(60) Provisional application No. 60/629,888, filed on Nov. 23, 2004.

(51) Int. Cl. G06Q 40/00

(52) U.S. Cl. 705/40

(57) ABSTRACT

The invention includes a method and system for providing services to customers on behalf of a distributor. In particular, a method and system by which a school can provide financial services to students is provided. A system manager maintains relationships with a plurality of service providers, each providing a service and configures a computer-based system by which those services are distributed to students on behalf of the school. The system manager distributes the services by receiving electronic data from the school, validating the data, and transmitting the data to a first service provider; and branding at least one service with school identification information.

### CROSS-REFERENCE TO RELATED APPLICATIONS

This application claims the benefit of provisional application 60/629,888 filed Nov. 23, 2004, which is hereby incorporated by reference in its entirety.

### FIELD OF THE INVENTION

The present invention relates to financial aid online applications and specifically, to a method and system for servicing student financial needs.

### BACKGROUND OF THE INVENTION

Almost all students attending college require financial-related services, which can include, for example, services from tuition payment and billing to shopping at the school's store. For this reason, institutions of higher learning have been struggling with the challenge of trying to efficiently and effectively serve the financial needs of their student bodies. These schools are searching for ways to streamline their offices and provide value-added solutions to their students and parents. These institutions would not only like to offer convenient servicing options, but would like to have an efficient and effective method of servicing the financial needs of students.

Schools have turned to third parties to help them provide services that are readily accessible to students to encourage students to take a greater role in managing their own financial needs. There are numerous products and services being marketed related to the multitude of students' financial needs; however, each product only addresses a small number of students' needs. Thus, institutions have to manage numerous products and services, troubleshoot various problems, and deal with multiple parties. This makes providing comprehensive student financial services burdensome and cumbersome for the institutions.

It would be advantageous to have a system by which a single outside entity could provide comprehensive online managing and processing systems to assist schools. Thereby, schools could be relieved of the burden of managing various products and services. This would also be an advantage to students, who would have access to electronic methods to manage and process their financial needs in a coherent manner.

For this reason, there is a need for a computer-based support system that can provide and manage a single, in-depth management servicing system that can efficiently and effectively manage numerous student services.

### BRIEF SUMMARY OF THE INVENTION

Exemplary embodiments of the invention include a method and system for providing services to customers on behalf of a distributor. According to one aspect, method and system is provided by which a school can provide financial services to students. The services can include an electronic bill presentment and payment service, a tuition payment plan service; a billing statement processing service, an interactive voice response payment service, a tax form filing service; an online shopping service, and an advance payment service.

A system manager maintains relationships with a plurality of service providers, and configures a computer-based system by which those services are distributed to students on behalf of the school. The system manager distributes the services by receiving electronic data from the school, validating the data, and transmitting the data to a first service provider; and branding at least one service with school identification information.

### BRIEF DESCRIPTION OF THE DRAWINGS

The foregoing and other advantages of the invention will become more apparent from the detailed description of exemplary embodiments provided below with reference to the accompanying drawings in which:

FIG. 1A is a block diagram overview of the system and environment, according to an exemplary embodiment of the invention;

FIG. 1B is a functional block diagram of the exemplary sub-modules within the business module constructed in accordance with the invention;

FIG. 2 is a block diagram of the method containing the steps related to the integrating of a school into the system of the claimed invention, according to an exemplary embodiment of the invention;

FIG. 3 is a block diagram of the method containing the steps related to using the system of FIGS. 1A and 1B for the process of making a payment, according to another embodiment of the invention;

FIG. 4 is a block diagram of the method containing the steps related to using the system of FIGS. 1A and 1B for providing electronic bill presentment and payment, according to another embodiment of the invention;

FIG. 5 is a flowchart of the method containing the steps related to using the system of FIGS. 1A and 1B for the process of creating a tuition payment plan, according to another embodiment of the invention;

FIG. 6 is a flowchart of the method containing the steps related to using the system of FIGS. 1A and 1B for the process of producing billing statements, according to another embodiment of the invention;

FIG. 7 is a flowchart of the method containing the steps related to using the system of FIGS. 1A and 1B for the process of making a payment using interactive voice response, according to another embodiment of the invention;

FIG. 8 is a flowchart of the method containing the steps related to using the system of FIGS. 1A and 1B for the process of online shopping, according to another embodiment of the invention;

FIG. 9 is a flowchart of the method containing the steps related to using the system of FIGS. 1A and 1B for the process of scheduling advance payments, according to another embodiment of the invention; and

FIG. 10 is a flowchart of the method containing the steps related to using the system of FIGS. 1A and 1B for the process of preparing and filing tax forms, according to another embodiment of the invention.

### DETAILED DESCRIPTION OF THE INVENTION

The present invention provides a computer-based system and method for managing services and accounts. The term “system manager” refers to an institution or organization that provides the support functions between a distributor who offers services to an end user and third-party servicers who provide the services on behalf of the distributor. The term “school” refers to any institution of higher learning or any organization or business facilitating student services. In the embodiments described below, the school is the distributor. It should be understood, however, that other institutions or businesses can be the distributor and the system can be configured to accommodate the financial service needs of such institutions or businesses and their customers. The term “student” refers generally to an end user of services offered by a distributor.

In an exemplary embodiment of the invention, the system allows a distributor, e.g., a school, to offer its customers, e.g. students, a variety of services, such as financial related services, at a single location via the Internet. The services can be provided by a system administrator or a third party. However, since the distributor offers the services to the customers, customers are able to directly interact with only the distributor. Thus, the customer is provided with a simple and efficient way to obtain the services. Additionally, the system relieves the distributor of the responsibility to provide and manage such services on its own, which can be difficult and time consuming. Further, the distributor can deal directly with the system manager 180 without the added complication of dealing with multiple parties to offer comprehensive services.

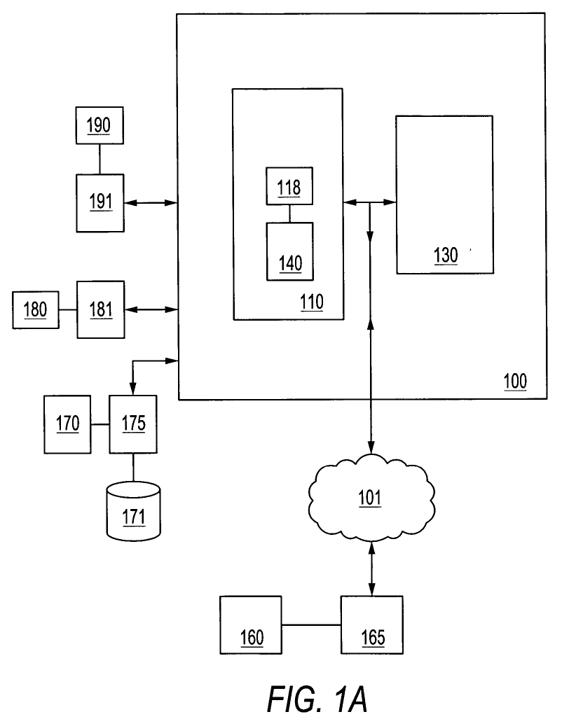

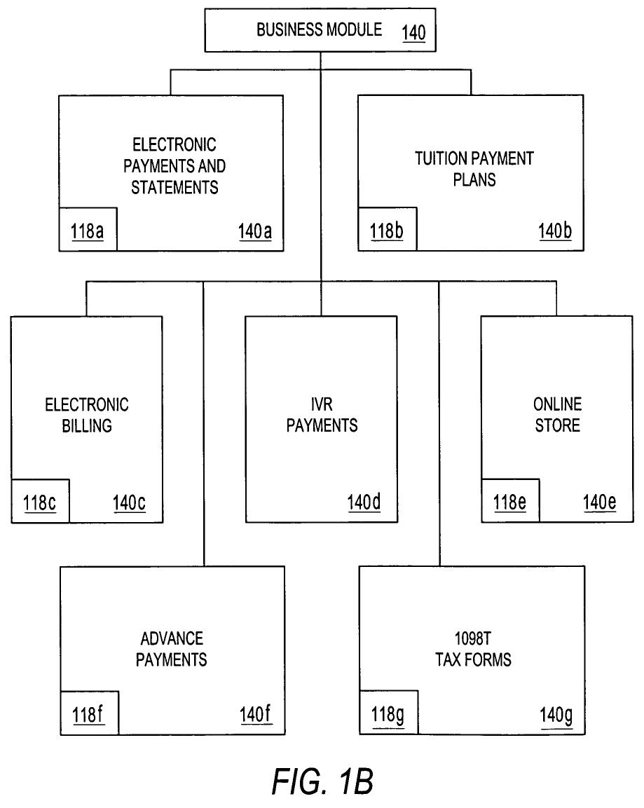

Referring now to FIGS. 1A and 1B, FIG. 1A shows an overview of an exemplary system 100. The system 100 can be implemented as the framework for an educational student services support system or any other type of student services oriented environment. The system 100 is managed by a system manager 180 via its computer network 181. The distributor is a school 190, which interacts with the system 100 through its computer network 191. Services are provided by one or more third party application service providers (ASPs) 170, each of which interacts with the system 100 through a computer network 175, which is in communication with a storage device 171, such as a database. The customers are students 160, who use client computers 165 to access the system via the Internet 101, or other computer network (not shown).

The system 100 comprises a server 110 and database storage device 130. The system 100 also includes a business module 140 for allowing a system manager 180 to coordinate financial services offered by a school and provided by third-party application service providers (ASPs) 170. The business module 140 can be a computer program application running on server 110.

The database storage device 130 can take the form of any non-volatile storage hardware including but not limited to optical, magnetic, semi-conductor, or tap storage or virtual storage in a WAN setting. The database storage device 130 stores information regarding the student 160, the school 180 (or other institution), and all information gathered by the business module 140.

A web site 118, which provides a user interface for students 160 and the school 190 to interact with the system 100 and business module 140 is also included in the system 100. In the illustrated embodiment, the web site is hosted by the server 110, but the web site 118 could instead be located on a different server than the business module 140.

Using the system 100, the system manager 180 acts as a conduit between a school 190 and at least one ASP 170 using system 100. The ASP 170 can be, for example, a bank or other financial service provider. The business module 140 allows the school 190 to interact with the system manager 180 to enable the school to offer services, such as managing the processes for servicing loans, setting tuition payment schedules and providing an online store, among others. The business module 140 also enables the ASPs 170 to interact with the system manager 180. The system manager 180 manages the services that are provided by the ASPs 170 and offered by the school 190.

The business module 140 is comprised of several sub-modules, which correspond to various services, as described in more detail below. A functional block diagram of these sub-modules is illustrated in FIG. 1B. The business module arrangement may utilize any combination of these sub-modules, but preferably includes all of the sub-modules. The sub-modules include a system that generates 1098T tax reports 140a, a system that allows students to make advance payments 140b, a system for making payments through a school's web site 140c, a system for furnishing electronic billing statements 140d, a system for creating a tuition payment plan 140e, a system for making payments using interactive voice response 140f, and a system for online shopping 140g. The business module 140 can include additional sub-modules as desired, for example a sub-module for enabling a lock box

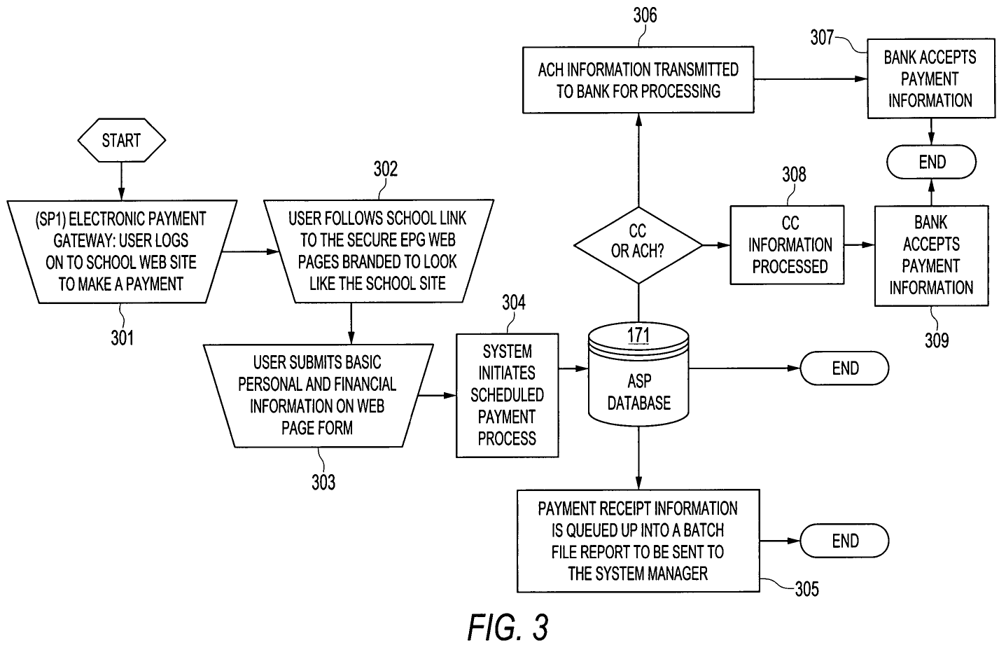

Each of the sub-modules 140a-g can include a user interface 118a-g, which can be a web site or simply a web page of the business module web site 140 or other user interface by which users of the modules can interact with the modules. Where a user interface 118a-g is a web site or page, the business module web site 140 can serve as an access point for one or more sub-modules 140a-g by providing links to the sub-module web site or page on the business module web site 118. The business module 140 and its corresponding sub-modules 140a-g may each require student users 160 to input login information in order to gain access to the functionality of the web sites 118, 118a-g. In one embodiment, a single log-in page on the business module web site 118 is used to access one or more of the sub-modules 140a-g. The sub-modules are described in more detail below in connection with FIGS. 3-9.

Through the system 100, the system manager 180 enables a school 190 to offer online financial services (e.g., via sub-modules 140a, 140g) to its students 160. The manager 180 can offer services by third-party ASPs 170 (e.g., via sub-modules 140b, 140c, and 140f) through the system 100, as well as its own services. Additionally, the system 100 also provides financial services to the school 190, for example, billing services and tax reporting services, among others.

To coordinate financial services offered by a school and provided by third-party application service providers (ASPs) 170, the system manager 180 maintains a relationship with the ASPs 170. The system manager 180 is responsible for managing the services offered through the system 100, such that the services are provided to the school 190 and its students 160. For example, it is the system manager 180 that contracts with third-party ASP 170 to implement one or more of the sub-modules 140a-g (FIG. 1B) though which the ASP's services are offered. Further, the system manager 180 receives incoming data files from the school's computer network 191, and ASP's computer network 175 and transmits processed data files to intended recipients. For processes where data is to be exchanged between a school 190 and one of the ASPs 170, the system manager 180 functions as an intermediary recipient of the data and validates the data, for example, by ensuring that the data is in the proper format to be received and utilized by the recipient's network before forwarding it to the appropriate recipient. Also, the manager 180 can brand the services, for example, by branding the web sites 118, 118a-g where the students 160 access the services. In this manner the students 160 are presented with a user interface identified with the school 190, for example, by containing the school's name and logo.

Schools 190 can have the system manager 180 customize the business module web site 118 to give it the same look and feel as the school's web site, as well as offer flexible payment options. For example, with the business module 140, schools 190 can easily, through the system 100 and with the aid of the system manager 180, customize the overall look and feel of their online store (sub-module 140g), among others.

In the illustrated embodiment, a third-party ASP 170 conducts the processing of payments received on the system manager's behalf. These payments are through the services that the third-party companies 170 host, including the sub-modules 140b, 140c, 140d, 140e (FIG. 1B) for the advance payment system, electronic payment gateway, electronic billing, and tuition payment plan. The business module 140 and sub-modules 140a-g can be implemented to use ACH credits for refunds and financial overpayments, as well as a point of sales system for check conversion, credit card and debit card processing.

The business module 140 also helps make university administration more effective, efficient and flexible by offering students, alumni and others fast efficient and secure payment transactions on or off-line. For example, the business module 140 can include sub-module 140e for implementing a tuition payment plan that allows students and their families to schedule payments by semester or annually, on-line, or through traditional methods, and receive counseling on payment options.

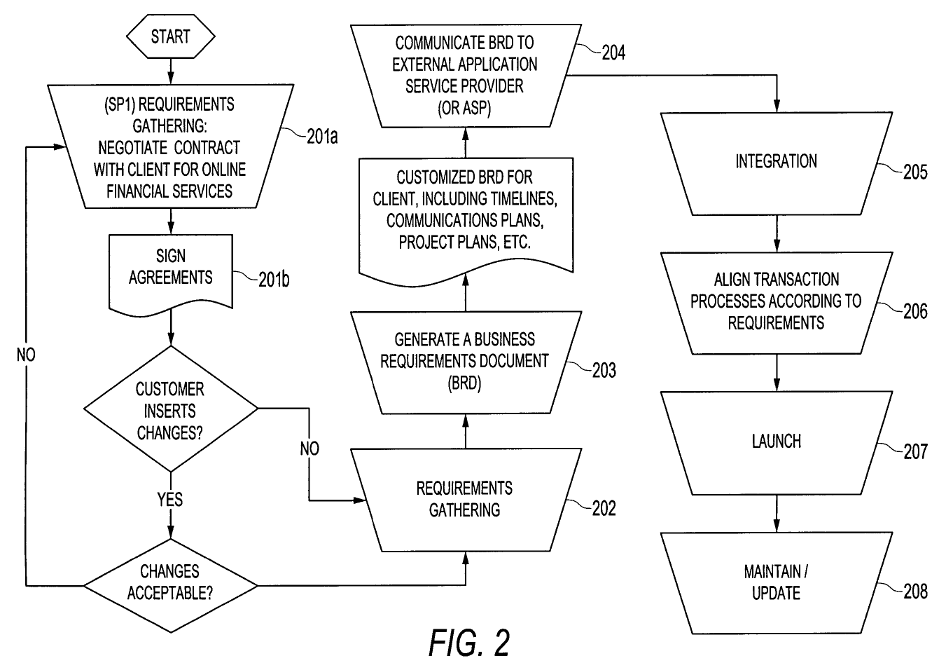

FIG. 2 illustrates the process by which a school 190 implements the system 100 according to an exemplary embodiment of the invention. Referring to FIG. 2, a system manager 180 and school 190 enter into an agreement to determine the services and system 100 to be provided by the system manager 180. In step 201a, the system manager 180 enters into a system manager/school standard agreement for the business module 140. The agreement is signed in step 201b. Then, in step 202, the system manager 180 and school 190 will identify all the requirements and features desired by the school 190 to be implemented by the business module 140 (e.g., which sub-modules 140a, 140b, 140c, 140d, 140e, 140f, and/or 140g to include). In step 203, the system manager 180 generates a business requirements document (BRD) setting forth such factors as timelines, communications plans, project plans, etc., as set forth from step 202.

In step 204, the system manager 180 will communicate the agreed upon BRD with a third party application service provider (ASP) 170 and coordinate to incorporate means for providing the ASP's services in the business module 140. Services from multiple ASPs 170 can be supported by the system.

In step 206, the system manager 180, the ASPs 170; e.g. banks, web application service provides, among others; work to align transaction processes according to the BRD requirements. Once the transaction processes are aligned, the school 190 can begin offering the ASP's services using the business module 140 as described below.

In step 207 the system 100 is launched and the school 190 and students 160 can begin using the system 100 as described below. Changes and updates to the system 100 are performed as needed, in step 208.

FIG. 3 illustrates a sub-module according to an exemplary embodiment of the invention for making electronic payments using sub-module 140a of the business module 140.

Referring to FIG. 3, the student 160 can make payments through the business module 140 using a student computer 165. In step 301, the student 160 accesses the school's web site, which includes a link to the business module web site 118. The student 160 then, in step 302, follows the link to the business module web site 118 and from there, to a secure electronic payment gateway (EPG) web page 118a. The web site 118 and page 118a can be branded and designed to look like the school's web site. Alternatively, the student 160 can simply access the business module web site 118 directly.

In step 303, the student 160 submits basic personal and financial information on a web page form. In response, the system 100 will initiate a scheduled payment process. After initiating a scheduled payment process, in step 304, the information is forwarded to the third party ASP database storage device 171. If the payment is an ACH payment, in step 306 the ACH information is transmitted by the ASP 170 to the school's bank, which accepts the payment information in step 307. If the payment is a credit card payment, in step 308, the payment information is processed to determine if the payment cleared. If the payment cleared, the school's bank accepts the payment information in step 309.

In the preferred embodiment, at step 305, the information submitted by the student 160 or multiple students into the database 130 is collected periodically and placed into a batch reporting file that the sub-module 140a will forward to the system manager 180. The information is then forwarded to the school 190 by the system manager 180. This batch reporting file provides schools 190 with a summary of all transactions that have occurred in the sub-module 140a during the respective period.

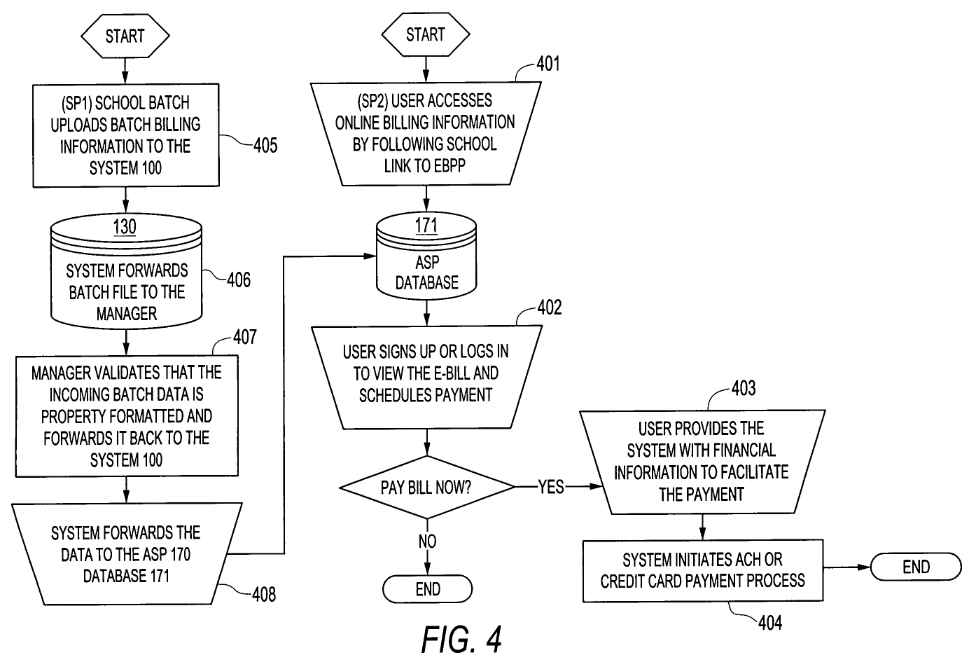

FIG. 4 illustrates the electronic bill presentment and payment (EBPP) services, which are also supported by the module 140a. In step 401, the student 160 accesses online billing information by following a link on the school's web site to the business module web site 118 and specifically to the EBPP web page 118a. Once at the web page 118a, in step 402, the student 160 can view the e-bill which is stored on the ASP database 171 and can also schedule payment. If the student 160 agrees to pay the bill at that time, in step 403, the student 160 provides the sub-module 140a with such financial information to facilitate the completion of the payment. In step 404, once the student 160 successfully submits payment and financial information, the sub-module 140a initiates the merchant processing process described below to complete the payment.

To input billing information, the school 190 sends the billing information, e.g. in a batch file, to the sub-module 140a step 405.

At step 406, sub-module 140a sends the billing information to the system manager 180. The system administrator 180 ensures that the data is properly formatted. Once the system administrator 180 confirms the program format of the data, it sends the data back to the sub-module 140c at step 407. At step 408, the sub-module 140a sends the billing information to the ASP database 171.

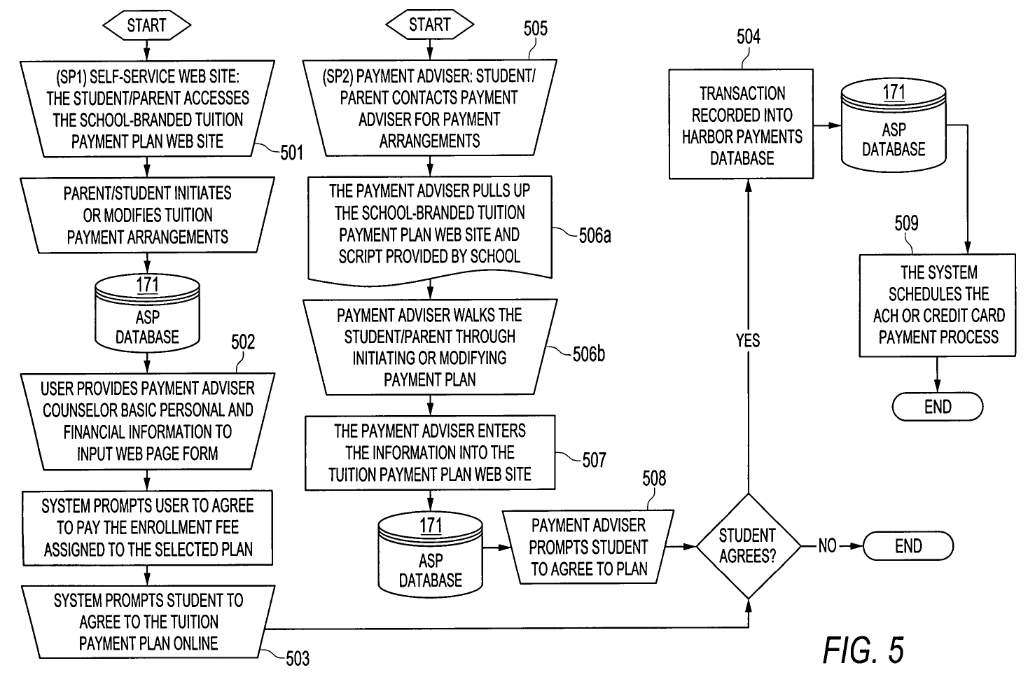

FIG. 5 illustrates another sub-module according to an exemplary embodiment of the invention. FIG. 5 illustrates the process used to create a tuition payment plan using the business module 140, sub-module 140b. In step 501, the student 160 accesses the school-branded tuition payment plan web page 118d through the school's web site. On the tuition payment plan web page 118b, the student 160 can initiate or modify their tuition payment arrangements. The student 160 can also, in step 502, pay any tuition arrangements by providing the sub-module 140b with basic personal and financial information and inputting the information on to a web page form. If the student 160 simply initiates their payment arrangements, the sub-module 140b will, in step 503, cause the system 100 to prompt the student 160 to agree to the tuition payment plan online. In step 504, if the student 160 agrees to the plan online, the transaction is recorded into the ASP database 171 and the sub-module 140b schedules the tuition payment process in step 509.

Alternatively, in step 505, the student 160 can contact the system manager 180 to make payment arrangements. In steps 506a and 506b, the system manager 180 would then access the web site 118b itself and walk the student 160 through the steps of initiating or modifying a payment plan using the method described above. In step 507, the system manager 180 would directly enter the information into the web site 118b and prompt the student 160 to agree to the plan rather than the student doing so (step 508). As above, if the student 160 agrees to the plan, in step 504, the transaction is recorded into the database storage device 130 and the sub-module 140b schedules the tuition payment process in step 509.

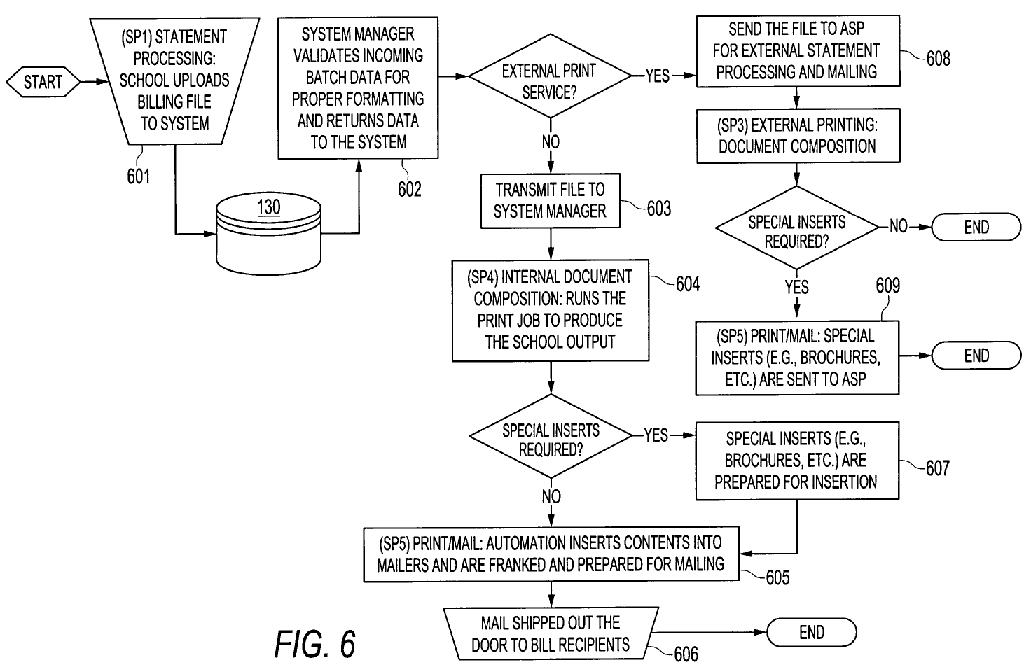

FIG. 6 illustrates another sub-module according to an exemplary embodiment of the invention. FIG. 6 depicts the process by which schools 190 can produce billing statements using sub-module 140c. Referring to FIG. 6, the business module 140 can provide schools 190 with statement processing services. In step 601, the school 190 would upload billing files to the system 100 where it is stored on the storage device 130. In step 602, the billing information is validated and properly formatted by the system manager 180 into billing documents and saved on the storage device 130. If the printing service is to be provided by the system manager 180, in step 603, the sub-module 140c transmits the billing files to the manager's network 181. The documents are then printed to produce a school's billing output in step 604. The school's output includes all billing statements generated related to that particular school. Optionally, in step 607, the sub-module 140c can prepare and add special inserts such as brochures if the school 190 or system manager 180 so desires. In step 605, the special inserts are automatically inserted into the billing documents and are prepared for mailing. In step 606, the system manager 180 directly ships mail to the students 160.

If a third party ASP 170 is to print the billing statements, in step 608, the sub-module 140e transmits the billing files to the ASP network 175 for printing and mailing. If special inserts are to be added, the inserts are also sent to the ASP network 175 in step 609.

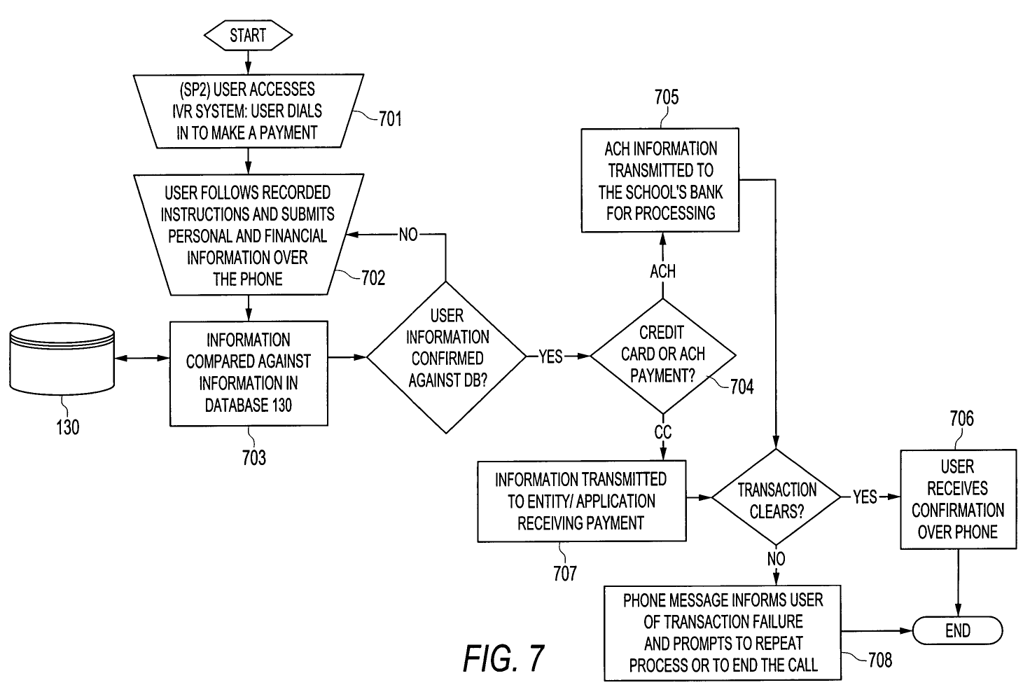

FIG. 7 illustrates another sub-module according to an exemplary embodiment of the invention. FIG. 7 shows the process used to make payments using interactive voice response, i.e., sub-module 140d. In step 701, the student 160 dials in to access the IVR sub-module 140d and access the user interface 118d. In step 702, the student 160 follows a set of recorded instructions and submits their login information and other information, such as basic personal and financial information, over the phone. In step 703, the sub-module 140d will then compare the information received against the information stored in the storage device 130.

In step 704, if the student's information is confirmed by the sub-module 140d, the payment process is initiated. If the payment is made by ACH payment, the transaction information is transmitted to the school's bank for processing. In step 706, if the transaction clears, the school's bank 175 will accept the payment information and sub-module 140d will give the student 160 confirmation over the phone. Alternatively, if the payment is by credit card, in step 708, the sub-module 140d transmits the transaction information to the entity or application receiving the payment on behalf of the school 190, e.g., sub-module 140a.

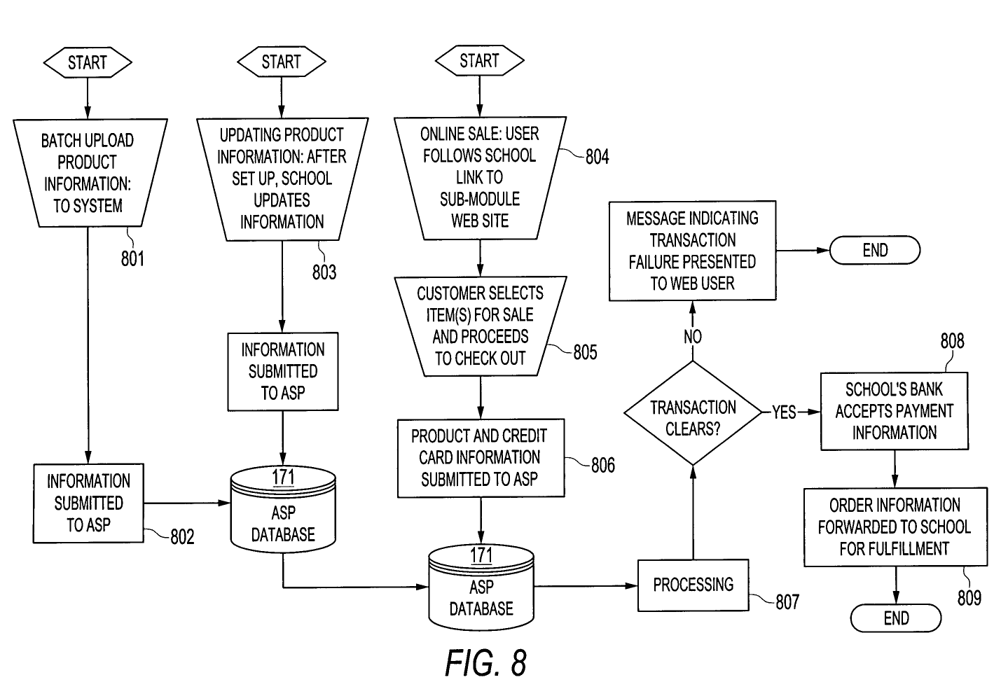

FIG. 8 illustrates another sub-module according to an exemplary embodiment of the invention. FIG. 8 depicts the process of using sub-module 140e, to provide an online shopping feature. Sub-module 140e provides additional revenue sources for institutions by enabling schools to sell school products, collect donations online, sell tickets to campus events and more.

Referring to FIG. 8, the business module 140 can include sub-module 140, which includes an online shopping web site 118e. In the illustrated embodiment, a third party ASP supports the sub-module 140g web site 118g. In step 801, the school 190 uploads its product information to the sub-module 140e. Alternatively, the school 190 can send product information to the system manager 180 for uploading to the sub-module 140g. In step 802, the uploaded product information is submitted to the ASP database 171, where it is stored. The school 190 can continuously update the product information through the sub-module 140e in step 803.

In step 804, the student 160 follows the link on the school's web site to access the online shopping web site 118e. In step 805, the student 160 selects an item or items for sale from among those items presented on the online shopping web site 118e and proceeds to the check out function. In step 806, the student 160 submits payment information, such as credit card information. The product and payment information is then submitted to the ASP 170 and stored in the database 171. In step 807, the ASP 170 processes the payment information. If the transaction clears, in step 808 the school's bank 175 will accept the payment information. In step 809, the sub-module 140e forwards information about the product order to the school 190 so that the school 190 can fulfill the order. It should be appreciated that the online shopping component of business module 140 is not limited to being used by only students 160. The system 100 can be used also by parents, alumni, employees or any other individual interested in purchasing items from the school 190.

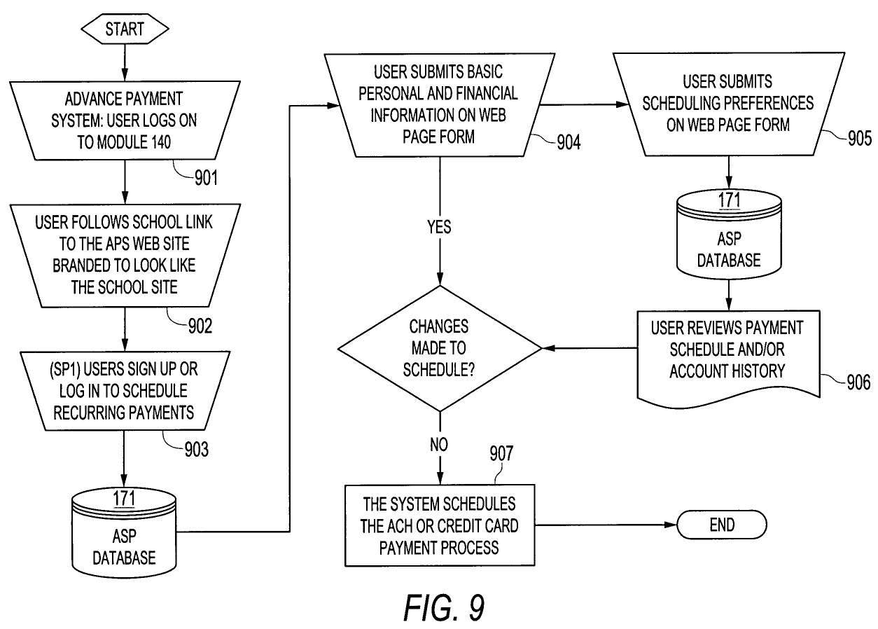

FIG. 9 illustrates another sub-module according to an exemplary embodiment of the invention. FIG. 9 illustrates the process used to make advance payments, i.e., sub-module 140f. Referring to FIG. 9, the business module 140 provides an Advance Payment System (APS) which allows the student 160 to have payments automatically made by the sub-module 140b. In step 901, the student 160 logs on to the business module web site 118 and, in step 902, follows the link to the sub-module APS web site 118f. In step 903, the student 160 can schedule recurring payments or can make one payment using the advance payment system. In step 904, the student 160 submits basic personal and financial information on the web page form. In step 905, the user also submits payment scheduling preferences on a web page form. The payment information is submitted through the sub-module 140b to the ASP database 171. In step 906, the student 160 can review their payment schedule and their account history and decide whether to make changes to the payment schedule. If no changes are necessary or made by the student 160, in step 907, the sub-module 140f will continuously process the payments and make the scheduled payments automatically using the recorded payment information.

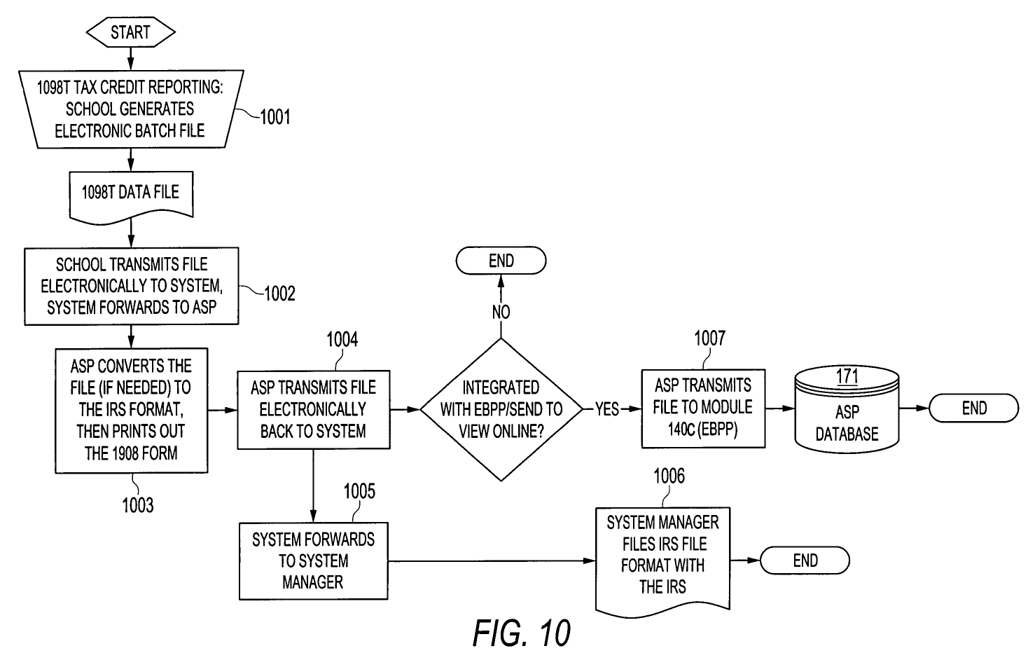

FIG. 10 illustrates another sub-module according to an exemplary embodiment of the invention. FIG. 10 illustrates the process for generating and filing a 1098T Tax Credit reporting form using sub-module 140g. In step 1001, the school 190 generates an electronic file containing the information to be input into the 1098T Forms. In step 1002, the school 190 sends the file to the sub-module 140g, for example, by accessing the web site 118g and uploading the file. The sub-module 140g forwards the file to an ASP 170. The ASP 170 converts the file to the IRS format and prints the completed 1098T Forms in step 1003. In step 1004, the ASP 170 transmits the converted file back to the sub-module 140g, which, in step 1005, forwards the file to the system manager 180. The system manager 180 manually files the 1098T Forms with the IRS.

If the sub-module 140g is configured to interact with sub-module 140a (FIG. 1B), the electronic bill presentment and payment system, the ASP 170 will transmit the converted file to the sub-module 140a, where it is submitted for storage on the ASP database 171 associated with sub-module 140a. Using sub-module 140a, students 160 are able to access their 1098T Form.

It should be appreciated that the business module 140 can also provide school's 190 any queries about existing student or school accounts related to any of the sub-modules 140a-g described above. For example, all ASPs 170 can transmit electronic data regarding the transactions related to the school 190 (e.g., electronic receipts for payments made to the school, among others) to the system manager 180. The system manager 180 validates the data and forwards the data to the school 190, along with any data regarding transactions completed by the system manager 180 on behalf of the school 190.

Having described specific preferred embodiments of the invention with reference to the accompanying drawings, it is understood that the invention is not limited to those precise embodiments, and that various changes and modifications may be effected therein by one skilled in the art without departing from the scope or the spirit of the invention as defined in the appended claims.

What is claimed as new and desired to be protected by Letters Patent of the United States is:

1. A computer system, the system comprising:
a computer network;
at least one server in communication with the computer network;
a storage device for storing information;
at least one website linked to the at least one server through the computer network, wherein the website provides a user interface through which a user can access a plurality of services, the plurality of services being offered by a plurality of service providers; and
a business module configured to facilitate the distribution of the plurality of services to the user by a distributor such that the customer receives the services on behalf of the distributor and to enable the distributor to interact directly with only a single service provider.

2. The computer system of claim 1, wherein the user is a student and the distributor is a school.

3. The system of claim 1, wherein the business module is further configured to receive data from the distributor and the plurality of service providers and forward the data to the single service provider.

4. The system of claim 1, wherein the plurality of services comprise two or more of the services selected from the group consisting of: an electronic bill presentment and payment service, a tuition payment plan service; a billing statement processing service, an interactive voice response payment service, tax form filing service; an online shopping service, and an advance payment service.

5. A system for providing financial services in connection with a school, the system comprising:
a computer network;
at least one server in communication with the computer network;
a storage device for storing information;
a business module configured to facilitate distribution of a plurality of student services such that a student receives the services on behalf of the school; and to enable the school to directly interact with a single service provider;
at least one web site linked to the at least one server through the computer network, wherein the web site provides a student user interface through which the student can access the plurality of student services;
a school user interface through which the school can interact with the business module.

6. The system of claim 1, wherein the plurality of services comprise two or more of the services selected from the group consisting of: an electronic bill presentment and payment service, a tuition payment plan service; a billing statement processing service, an interactive voice response payment service, tax form filing service; an online shopping service, and an advance payment service.

7. A method of providing financial related services, the method comprising the acts of:
maintaining relationships with a plurality of service providers, each providing a service;
configuring a computer-based system by which the plurality of services are distributed to users on behalf of a distributor;
distributing the plurality of services; and
managing distribution of the services by:
receiving electronic data from the distributor, and
transmitting the data to a first service provider; and
branding at least one service with distributor information.

8. The method of claim 7, wherein the plurality of services are financial services.

9. The method of claim 7, wherein the plurality of services comprises an electronic bill presentment and payment service.

10. The method of claim 9, wherein the act of distributing the electronic bill presentment and payment service comprises the acts of:
providing a user interface through which a user can make a payment;
receiving payment information in a web page form; and
transmitting the payment information to a service provider for processing of the payment.

11. The method of claim 9, wherein the act of distributing the electronic bill presentment and payment service comprises the acts of:
receiving electronic billing data from a distributor, the billing data containing billing information for at least one user;
validating the electronic billing data;
forwarding the validated electronic billing data to a service provider for presentment to a respective user via the Internet.

12. The method of claim 7, wherein the plurality of services comprises tax form filing services.

13. The method of claim 12, wherein the act of distributing the tax form filing service comprises the acts of:
receiving electronic tax data from a distributor, the tax data comprising information about at least one user and contained on a 1098T Form;
transmitting the electronic data to a tax service provider;
receiving electronic 1098T Forms for the at least one user from the tax service provider;
providing the at least one student access to the 1098T Form via the Internet.

14. The method of claim 13, wherein the act of distributing the tax form filing service further comprises the act of:
filing the 1098T Form with the Internal Revenue Service.

15. The method of claim 7, wherein the plurality of services comprises a tuition payment plan service.

16. The method of claim 15, wherein the act of distributing the tuition payment plan service comprises the acts of:
receiving input from a student to initiate or modify a tuition payment arrangement in a web page form;
prompt the student to agree to the terms of the tuition payment arrangement;
if the student agrees, storing the tuition payment arrangement to a service provider database.

17. The method of claim 7, wherein the plurality of services comprises a billing statement processing service.

18. The method of claim 17, wherein the act of distributing the billing statement processing service comprises the acts of:
receiving electronic billing data for a plurality of students from a school;
validating the electronic billing data;
transmitting the validated electronic billing data to a service provider for bill printing and mailing to respective students;
optionally transmitting insert information to the service provider to be printed and mailed with each printed bill.

19. The method of claim 7, wherein the plurality of services comprises an interactive voice response payment service.

20. The method of claim 19, wherein the act of distributing the voice response payment service comprises the acts of:
receiving voice input from a student;
comparing the voice input received against information previously recorded in a storage device; and
if the voice input is confirmed against the information in the storage device, proceeding to process a payment transaction.

21. The method of claim 7, wherein the plurality of services comprises online shopping services.

22. The method of claim 21, wherein the act of distributing the online shopping service comprises the acts of:
receiving electronic data comprising information about a plurality of products from a school;
transmitting the product data to a service provider for storage to a storage device;
providing a user interface through which a student can purchase at least one of the plurality of products;
receiving payment information for a selected item;
transmitting the payment information for the selected item to the service provider.

23. The method of claim 22, wherein the user interface is a web site branded with school identification information.

24. The method of claim 7, wherein the plurality of services comprises and an advance payment service.

25. The method of claim 24, wherein the act of providing the advance payment service comprises the acts of:
providing a user interface though which a student can schedule payments for a specified time;
receiving providing a user interface through which a student can make a payment;
receiving payment information in a web page form, the payment information comprising the time at which at least one payment is to be made; and
transmitting the payment information to a service provider for processing of the at least one payment at the specified time.

26. The method of claim 7, further comprising the steps of:
receiving payment transaction data from each service provider;
validating the data;
forwarding the data to the distributor.

27. A computer software program product embodied on a computer useable medium, comprising:
an interface module for providing a user interface through which a user can access a plurality of services, the plurality of services being offered by a plurality of service providers; and
a business application module for the distribution of the plurality of services such that the end user receives the services on behalf of a distributor and a communications module for interacting between the distributor and service provider.

28. The computer system of claim 27, wherein the user is a student and the distributor is a school.

29. The system of claim 27, wherein the plurality of services comprise two or more of the services selected from the group consisting of: an electronic bill presentment and payment service, a tuition payment plan service; a billing statement processing service, an interactive voice response payment service, tax form filing service; an online shopping service, and an advance payment service.

30. A computer system for providing services from a plurality of service providers on behalf of a distributor, the system comprising:
providing means for providing a user interface through which a user can access a plurality of services, the plurality of services being offered by a plurality of service providers; and
facilitating means for facilitating the distribution of the plurality of services to the user by a distributor such that the customer receives the services on behalf of the distributor and to enable the distributor to interact directly with only a single service provider.

31. The computer system of claim 31, wherein the user is a student and the distributor is a school.

32. The system of claim 31, further comprising a means for receiving data from the distributor and the plurality of service providers and forwarding the data to the single service provider.

33. The system of claim 31, wherein the plurality of services comprises two or more of the services selected from the group consisting of: an electronic bill presentment and payment service, a tuition payment plan service; a billing statement processing service, an interactive voice response payment service, tax form filing service; an online shopping service, and an advance payment service.
